(19) United States
(12) Patent Application Publication
(10) Pub. No.: US 2010/0205154 A1
(43) Pub. Date: Aug. 12, 2010

(54) System and Method for Storing and Retrieving Deleted Files

(76) Inventor: Gregory Beliczynski, Brooklyn, NY (US)

Correspondence Address: Gregory Beliczynski;#3A, 216 Eckford St, Brooklyn, NY, 11222, US

(21) Appl. No.: 12/367,534

(22) Filed: Feb. 8, 2009

(51) Int. Cl. G06F 17/30

(52) U.S. Cl. 707/665; 707/E17.032

(57) ABSTRACT

A system and method for storing deleted files from a plurality of computers so that the deleted files are available to be retrieved from a single location. This includes identifying one or more files flagged for deletion by a user on a local computer, updating a database with metadata describing the user and the deleted files, uploading the files to a memory storage apparatus on a remote computer, and providing a way to view and download the files from the remote computer. The system and method also includes an external memory storage apparatus that automatically downloads and store the deleted files.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of the Invention

The present invention is in the technical field of file storage and retrieval, and more specifically, the storage and retrieval of deleted files.

2. Prior Art

Throughout the course of an average day, a person may delete files from a plurality of computers, such as but not limited to: desktop computers, notebook computers, mobile phones and mp3 players. Examples of files that can be deleted from the aforementioned computers are program files, compressed files, document files, email files, and media files such as image files, video files and music files. Generally, once a file is deleted, the computer's operating system manages and executes the file deletion using one of two methods. The file is either moved to the computer's temporary local storage folder or “recycle bin” from where it can be restored at a later time, or the file is permanently removed from storage.

A major shortcoming of the recycle bin is that it currently only stores files deleted from hard drives, and not from removable media, such as memory cards and CD/DVD/Blu-ray Discs. It is also unable to store files deleted from network drives. Another limitation of the recycle bin is that its storage capacity is limited by its operating system and having a recycle bin that is relatively full can reduce the overall performance of your computer. To solve this performance issue, the recycle bin must be emptied regularly to free up disk space by deleting the files inside it. Therefore, since the recycle bin is only a temporary holding center for deleted files, it will eventually lead to permanent file deletion when emptied.

Executing permanent file deletion, whether via emptying out the computer's recycle bin, intentionally bypassing the recycle bin, or not having a choice because the user's computer does not support a recycle bin, has lead to many instances of accidental file loss or the deletion of trivial files that later prove to be important. Even though there are file retrieval methods available such as disk backup utilities and undelete utilities, they are not always considered to be reliable because the utilities are not supported by all file systems nor are they available for all computers. Furthermore, to better the chances for successful file retrieval, the file retrieval utilities need to be executed shortly after the file has been deleted as to prevent new files from overwriting to the same physical location where the deleted file currently resides. In many cases, by the time a user realizes that a deleted file needs to be retrieved, it is too late to be retrieved because a newly stored file has already taken over the delete file's space on the computer's memory storage apparatus. Also, in order to be able to restore deleted files using a disk backup or undelete utility, the computer's operating system may have to be functional, which in some cases it may not be if the user deleted a file required to run the operating system.

Another difficulty that arises from currently available methods of file deletion is that deleted files, whether moved to a recycle bin or permanently deleted, can only be retrieved if the user has physical access to each computer's memory storage apparatus. For example, if a user deletes files from a desktop computer's hard drive, then deletes other files from a notebook computer's hard drive, the user would need to have access to both hard drives if they were to attempt to retrieve both sets of files. The same goes for files deleted from a mobile phone or files deleted from a USB flash drive or network drive. Throughout the course of the day, a user may delete files from multiple drives across multiple computers. However, searching for and trying to retrieve all those deleted files can become a quite tedious and problematic task since they are not available to be retrieved from one location.

Therefore, what is needed is a system and method for storing deleted files from a plurality of computers and making them available to be retrieved from a single location. This is what the present invention accomplishes.

### BRIEF SUMMARY OF THE INVENTION

The present invention discloses a system and method for storing files deleted from a plurality of computers onto a memory storage apparatus on a remote computer, which can then be accessed and retrieved from a single computer. A software program, which can be an external application installed onto a computer's operating system, or hardware built into a computer's chipset, is running as a process on the local computer's operating system and programmed to detect the user action of deleting files. Once the software program detects that a file is about to be deleted, it moves the files into a temporary directory on the local computer's memory storage apparatus and then begins to upload the file to a remote computer, storing the file on the remote computer's memory storage apparatus. After the file has finished uploading to the remote computer, the temporary directory holding the deleted file on the local computer is deleted. Users can then use any computer with a network connection to log on to an account they have with the remote computer and use the remote computer's software to view and download all their recently deleted files.

The software program that detects and uploads deleted files to the remote computer can be coded in multiple programming languages in order to work on a plurality of supported computers such as desktop computers, notebook computers, mobile phones, and mp3 players. The software program can also be instructed to manage the deletion of files from all types of memory storage apparatuses that it encounters, including, but not limited to: files residing on hard disk drives, networked drives, removable media such as USB flash drives, and CD, DVD, and Blu-ray Discs.

In addition to logging on to a remote computer and using the remote computer's software to browse through and manually download recently deleted files, a user can also have the option of setting up a dedicated external drive or partitioning an existing internal disk drive, that when connected to the internet, will automatically download the user's recently deleted files to the external drive or partition.

### BRIEF DESCRIPTION OF DRAWINGS

Referring now to the drawings in which like reference numbers represent corresponding parts throughout:

FIG. 1 is a flow chart illustrating one preferred method for storing deleted files on a remote server according to the present invention;

FIG. 2 is a flow chart illustrating one preferred method for logging on to a remote computer to view and retrieve deleted files;

FIG. 3 is an example of a graphical user interface for viewing and retrieving deleted files from a web browser;

FIG. 4 is an example of a graphical user interface for viewing and retrieving deleted files from a desktop environment;

FIG. 5 is an illustration showing one preferred embodiment of an external memory storage apparatus for downloading deleted files from a remote server;

FIG. 6 is a diagram illustrating how an external memory storage apparatus downloads deleted files stored by the present invention; and

FIG. 7 is a flow chart illustrating one preferred method for downloading deleted files to an external memory storage apparatus.

### DETAILED DESCRIPTION OF THE PREFERRED EMBODIMENT

Illustrative embodiments of the invention are described below. In the interest of clarity, not all possible features of an actual implementation are described in this specification. It will of course be appreciated that in the development of any such actual embodiment, numerous implementation-specific decisions will be made to achieve the developers' specific goals, such as compliance with system-related and business-related constraints, which will vary from one implementation to another. Such a development effort may be complex and time-consuming, but would nevertheless be a routine undertaking for those of ordinary skill in the art.

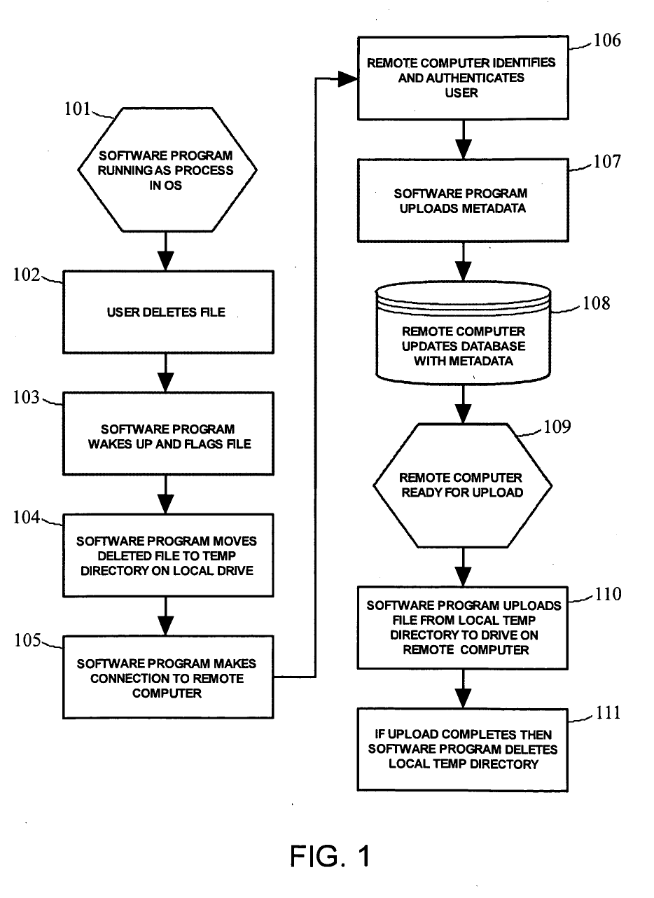

Referring to FIG. 1, a software program has been instructed to run as a process on a local computer's operating system in procedure 101. The software program can be an application installed onto a computer's operating system or code packaged into the existing source code of the computer's operating system. The software program can also be coded in various programming languages such as JAVA, .NET, C, C++, Assembly, etc., as to be compatible with a plurality of different computers and their respective operating systems. For example, one version of the software program can be made to run on a desktop PC running Windows, another version can be made to run on a Mac notebook running OS X, and yet another version can be made to run on a Blackberry mobile phone running the BlackBerry OS. The software program is also user-dependent, requiring each user to set up a username and password for each local computer that the software program is running on so that the software program can identify the user and correctly process the storage and retrieval of deleted files for the user.

In FIG. 1, when a user deletes files from a local computer at point 102, such as files from a computer running the Windows operating system, the software program, listening for the delete action, wakes up at point 103 and identifies the files flagged for deletion. The software program then moves the files instructed for deletion into a temporary directory on the local computer's memory storage apparatus 104. The temporary directory on the local computer's memory storage apparatus can be a folder on a hard disk drive whose path can be selected by the user beforehand as part of the software program's configuration preferences. Once the files have finished moving at point 104, the software program attempts to establish a network connection to a remote computer 105. An example of a remote computer can be a web server computer accessed via the internet or another computer on a Local Area Network (LAN). While the exact type of remote computer that the software program connects to can vary depending on factors like security and business needs, the general requirements of the remote computer, other than being able to communicate with the software program, are a memory storage apparatus and a database. If a connection cannot be established due to networking issues, then the software program will automatically retry connecting at a later time or according to a retry schedule, which once again, can be pre-selected by the user in the software program's configuration preferences.

If the software program successfully establishes a network connection with the remote computer, the software program will attempt to identify and authenticate the user of the local computer 106. Upon successful identification and authentication of the user, the software program transmits metadata to the remote computer pertaining to the file deletion process that occurred on the user's local computer 107. Examples of such metadata are filename, file size, date & time deleted, a unique identifier for the user that deleted the file, such as a username, and a source or label of the memory storage apparatus of the computer that the file was deleted from, such as “DESKTOP_HD” or “USB_FLASH_DRIVE”. The remote computer then stores the metadata in a database and associates it with the username 108. Once the database has been updated with metadata, the remote computer will communicate to the software program that it is ready for the upload to begin 109, which at point 110 the software program will begin uploading the files from the temporary directory of the user's local computer to a memory storage apparatus on the remote computer. The memory storage apparatus on the remote computer can preferably be a hard disk drive (HDD) or equivalent. Once the files have finished uploading to the remote computer's memory storage apparatus, the software program deletes the temporary directory with the files from the memory storage apparatus of the user's local computer 111.

In an alternative embodiment of the process outlined in FIG. 1, the moving of the files flagged for deletion to a temporary directory in procedure 104 can be bypassed so that the files are uploaded to the remote computer from their original location and then deleted from their original location once the upload to the remote computer has finished. The advantage of the preferred method that includes moving the files to a temporary directory is that it immediately removes the files from their current location, making room available for new files. For example, if a user deletes files from a file-cluttered desktop environment, they wouldn't have to wait for all the files flagged for deletion to upload to the remote computer before seeing them disappear and reduce clutter from the desktop environment.

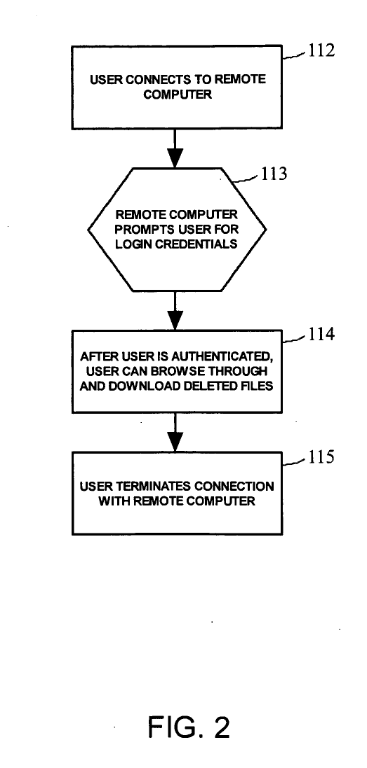

At point 111 the deleted files no longer exist on the user's local computer and are being stored on a remote computer with a database that can associate the files to the user. The next step of the invention is granting the ability to view and ultimately retrieve the deleted files, which turning now to FIG. 2, begins with the user connecting to the remote computer 112. If the remote computer is a web server, then the user would be able to use any computer capable of making an HTTP connection via a user agent such as a web browser to connect to the remote computer. If the remote computer was on a Local Area Network, then the user would generally have to be plugged in via Ethernet cable to connect to the remote computer or use a Virtual Private Network (VPN) adapter if supported by the remote computer. Another possible way to connect to the remote computer would be through Secure Shell (SSH). And so, due to the variety of network protocols, the look and feel of a user interface for viewing and retrieving deleted files stored on a remote computer can vary, but the general functionality should remain the same across all types of network connections.

All initial connections to the remote computer would require the user to login with a username and password 113, and once authenticated by the remote computer, the user is granted access to browse through and retrieve the deleted files 114. When finished, the user can also terminate the connection with the remote computer, either by logging out or by closing the web browser or other user agent used to connect to the remote computer 115.

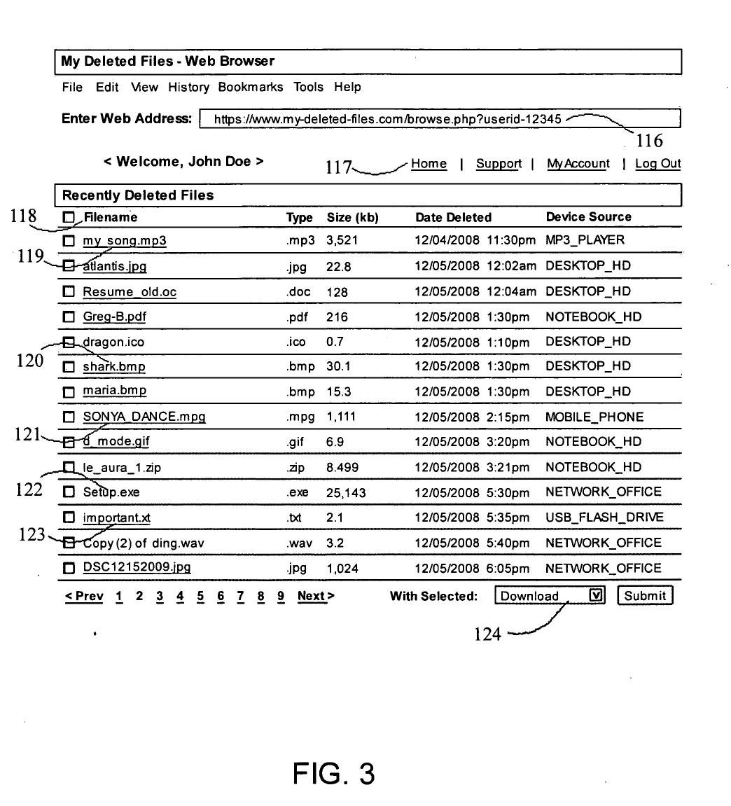

FIG. 3 is an example of how a graphical user interface (GUI) on a web browser would look like for browsing through and retrieving deleted files stored on a remote computer as outlined in the present invention. A vanity uniform resource locator (URL) 116 in the address bar points to a web server, the web server software, after having identified and authenticated the user, generates a detailed list of deleted files. The list deleted files is generated by referencing the metadata stored in the database from steps 107 and 108 in FIG. 1, which we can see translate into file properties such as “Filename”, “Size (kb)”, “Date Deleted” and “Computer Source” in 118 in FIG. 3. In 119, we can see that a filename “my_song.mp3” of MP3 file type and 3,521 kb in size was deleted on 12/04/2008 at 11:30 pm from the user's “MP3_PLAYER” computer. The filename is underlined or “hyperlinked” to signify that it is a supported media type that can be previewed by clicking on it. In the case of 119, it is an MP3 file that can be played within the web browser if the web browser has the correct plug-in to play the MP3 file. Moving further down the list of filenames, at 120 we see an image file of BMP file type deleted from the user's “DESKTOP_HD”, 121 is an MPG video file deleted from the user's “MOBILE_PHONE”, 122 is an executable file the user deleted from a network drive at the office, and 123 is a text file that was deleted from the user's removable memory storage apparatus labeled “USB_FLASH_DRIVE”. The user can select any number of these deleted files and perform an action on them such as retrieving the file via download 124. Other actions that can be performed with selected files at 124 include: having the files sent to an email address, scanned for viruses, or permanently deleted from the remote computer. Once finished, the user can terminate his or her session with the remote computer by closing the web browser or using the “Log Out” hyperlink found at the end of the row of hyperlinks at 117.

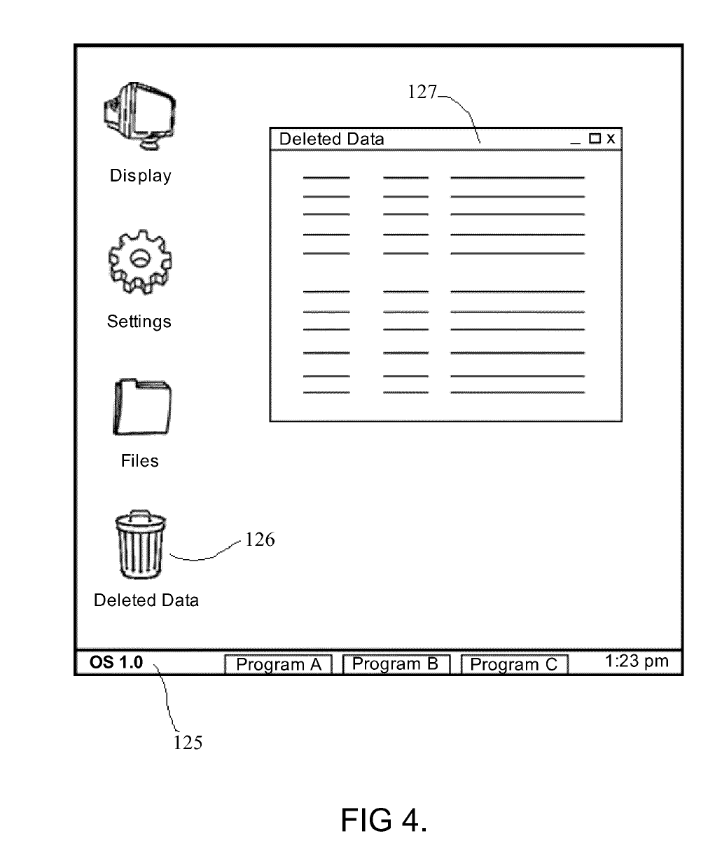

FIG. 4 shows a way to launch a similar graphical user interface for browsing and retrieving deleted files as outlined in the present invention, but without the use of a web browser. 125 is an example of an operating system's desktop environment, and 126 is an icon that launches an application that connects to the remote computer where the deleted files are being stored and displays a graphical user interface for viewing and retrieving the deleted files from a window 127 within the operating system. Once again, the appearance of the graphical user interface could vary slightly from the web browser graphical user interface shown in FIG. 3, but the general functionality remains the same.

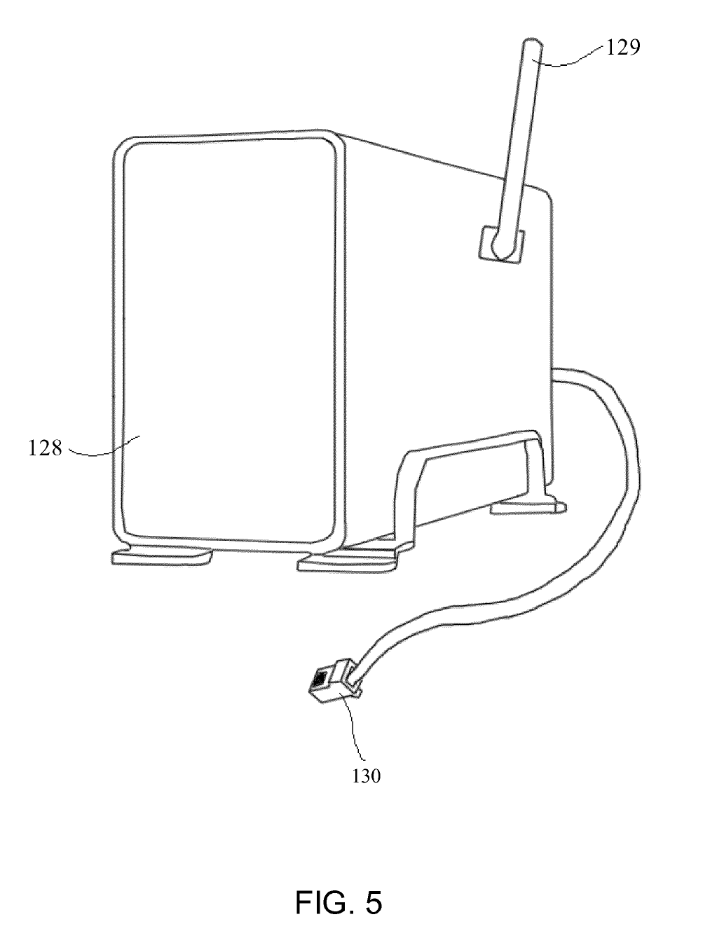

An alternative method for retrieving deleted files stored by the process outlined in the present invention is configuring the software program to automatically download the deleted files for the user, either to a folder or partition on a memory storage apparatus residing within a user's computer, or to an external memory storage apparatus whose preferred embodiment is illustrated in FIG. 5. In FIG. 5, an external memory storage apparatus whose primary storage can preferably consist of a hard disk drive or equivalent (not shown) is enclosed within a housing 128. Also residing inside the housing is a network adapter (not shown) capable of making wired network connections through an Ethernet cable 130, or wireless network connections through an antenna 129. A microcontroller (not shown) comprising a processor, memory and a software program for connecting to a remote computer and downloading deleted files is also enclosed within the housing.

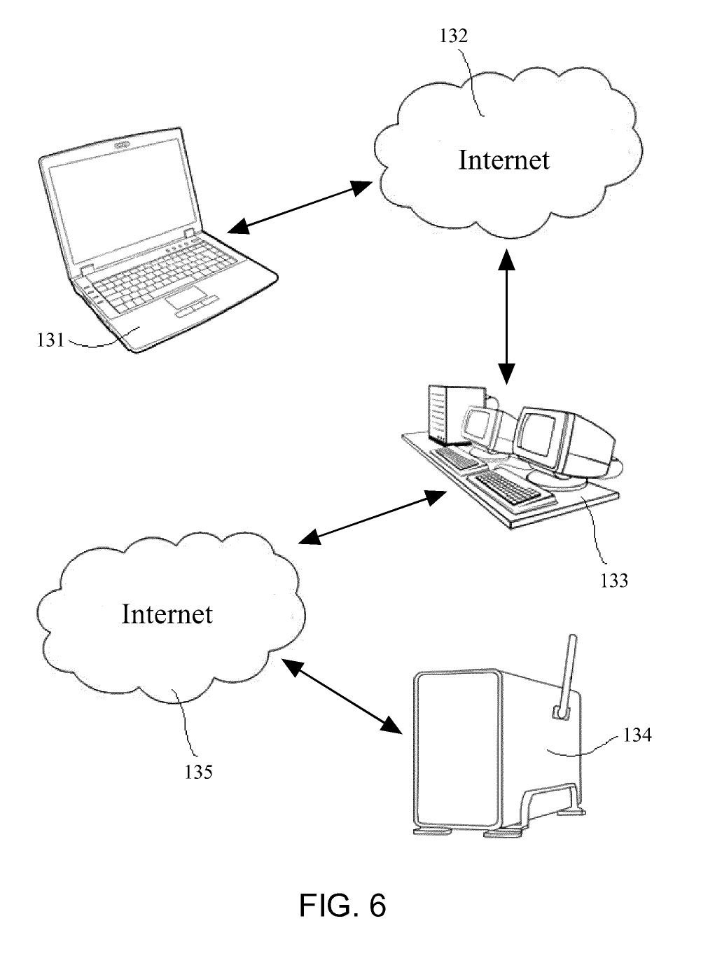

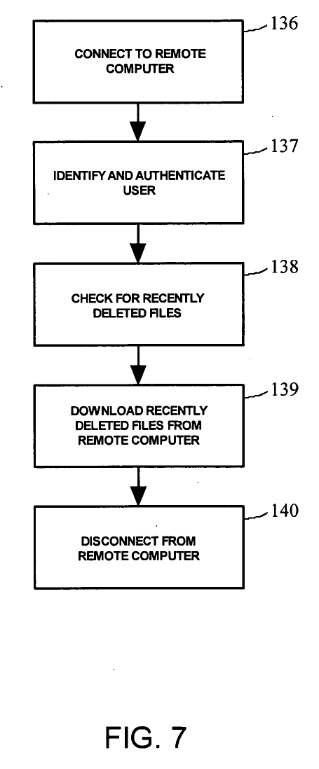

Turning now to FIG. 6, we can see how the external memory storage apparatus is used to automatically download deleted files within the context of the present invention. In FIG. 6, a user deletes files from a notebook computer 131 and the same software program embodied in FIG. 1 makes a network connection through the internet 132 and stores the deleted files onto a memory storage apparatus of a remote computer 133. The external memory storage apparatus 134 is programmed to routinely connect to the remote computer through the internet 135 and download the recently deleted files to its primary storage. The software program controlling this process is illustrated in greater detail in FIG. 7.

As shown in procedure 136 in FIG. 7, the software program utilizes the networking capability of the external memory storage apparatus to connect to the remote computer where the user's deleted files are being stored. The frequency of these connections can be set by going into the software program's configuration preferences. Once a connection with the remote computer has been established, the remote computer attempts to identify and authenticate the user of the external memory storage apparatus 137. After positively identifying and authenticating the user of the external memory storage apparatus, at step 138 the software program checks for any recently deleted files stored on the remote computer that have not yet been downloaded to the external memory storage apparatus, and if so, the software program initiates a download of those files 139 and stores the files onto the primary storage of the external memory storage apparatus. Once the download has finished, the software program disconnects from the remote computer at step 140. The end result is a locally accessible memory storage apparatus which has conveniently consolidated deleted files from a plurality of the user's computers into one physical location.

What is claimed is:

1. A method for storing a deleted file from one or more computers comprising the steps of:
a) identifying at least one file flagged for deletion by a user on a computer;
b) making a network connection to a remote computer;
c) storing the file on a memory storage apparatus on the remote computer; and
d) repeating steps (a) through (c) for subsequent files.

2. The method of claim (1), further comprising the steps of:
a) collecting metadata describing the user and the file flagged for deletion;
b) making a network connection to a remote computer; and
c) updating a database on the remote computer with the metadata, whereby associating the file with the user within the database.

3. The method of claim (2), wherein the metadata includes at least one unique identifier for the user and a filename with a full path to the file's location on the remote computer's memory storage apparatus.

4. The method of claim (1), further comprises a method for displaying at least one file stored on the remote computer comprising the steps of:
a) making a network connection to the remote computer;
b) identifying the user;
c) generating a list of files stored on the remote computer; and
d) presenting a user interface for viewing the list of files.

5. The method of claim (4), wherein the user interface is a graphical user interface.

6. The method of claim (4), wherein the user interface is a graphical user interface accessible from a web browser.

7. The method of claim (4), further comprises a method for retrieving at least one file from the list of files comprising the step of providing a means for downloading the file to a local memory storage apparatus.

8. A computer-readable medium carrying one or more sequences of instructions which, when executed by one or more processors, causes the one or more processors to perform the steps of:
a) identifying at least one file flagged for deletion by a user on a computer.
b) making a network connection to a remote computer;
c) storing the file on a memory storage apparatus on the remote computer; and
d) repeating steps (a) through (c) for subsequent files.

9. The computer-readable medium of claim (8), further comprising instructions for:
a) collecting metadata describing the user and the file flagged for deletion;
b) making a network connection to a remote computer; and
c) updating a database on the remote computer with the metadata, whereby associating the file with the user within the database.

10. The computer-readable medium of claim (8), wherein the metadata includes at least one unique identifier for the user and a filename with a full path to the file's location on the remote computer's memory storage apparatus.

11. The computer-readable medium of claim (8), further comprises instructions for displaying at least one file stored on the remote computer comprising the steps of:
a) making a network connection to the remote computer;
b) identifying the user;
c) generating a list of files stored on the remote computer; and
d) presenting a user interface for viewing the list of files.

12. The computer-readable medium of claim (11), wherein the user interface is a graphical user interface.

13. The computer-readable medium of claim (11), wherein the user interface is a graphical user interface accessible from a web browser.

14. The computer-readable medium of claim (8), further comprises instructions for retrieving at least one file from the list of files comprising the step of providing a means for downloading the file to a local memory storage apparatus.

15. A computer system, comprising:
a) a processor; and
b) a program storage device encoded with instructions that, when executed by the processor, perform a method for storing a deleted file from one or more computers, comprising:
i. means for identifying at least one file flagged for deletion by a user on a computer;
ii. means for making a network connection to a remote computer;
iii. means for storing the file on a memory storage apparatus on the remote computer; and
iv. repeating steps (a) through (c) for subsequent files.

16. The computer system of claim (15), further comprising:
a) means for collecting metadata describing the user and the file flagged for deletion;
b) means for making a network connection to a remote computer; and
c) means for updating a database on the remote computer with the metadata, whereby associating the file with the user within the database.

17. The computer system of claim (15), wherein the metadata includes at least one unique identifier for the user and a filename with a full path to the file's location on the remote computer's memory storage apparatus.

18. The computer system of claim (15), further comprises a means for displaying at least one file comprising the steps of:
a) means for making a network connection to the remote computer;
b) means for identifying the user;
c) means for generating a list of files stored on the remote computer; and
d) means for presenting a user interface for viewing the generated list of files.

19. The computer system of claim (18), wherein the user interface is a graphical user interface.

20. The computer system of claim (18), wherein the user interface is a graphical user interface accessible from a web browser.

21. The computer system of claim (15), further comprises instructions for retrieving at least one file from the list of files comprising providing a means for downloading the file to a local memory storage apparatus.

22. An external memory storage apparatus for retrieving one or more deleted files stored on a remote computer, comprising:
a) a microcontroller;
b) means for storage;
c) means for making a network connection to a remote computer;
d) a program storage device encoded with instructions that, when executed by the microcontroller, performs a method for downloading one ore more files from a remote computer and storing the files to its means for storage; and
e) a housing means for housing (a) through (d).

23. The external memory storage system of claim (22), wherein the means for storage is a hard disk drive.

24. The external memory storage system of claim (22), wherein the means for storage is a solid state drive.

25. The external memory storage system of claim (22), wherein the means for connecting to a remote computer is a wired connection.

26. The external memory storage system of claim (22), wherein the means for connecting to a remote computer is a wireless connection.

27. The external memory storage system of claim (22), wherein the housing means is metal.

28. The external memory storage system of claim (22), wherein the housing means is plastic.
